(19) United States
(12) Patent Application Publication
(10) Pub. No.: US 2015/0090718 A1
(43) Pub. Date: Apr. 2, 2015

(54) Portable Sail Protection Container

(71) Applicants: Suzanne Ron, Houston, TX (US); Daniel Ron, Houston, TX (US); Alexander Ron, Houston, TX (US)

(72) Inventors: Suzanne Ron, Houston, TX (US); Daniel Ron, Houston, TX (US); Alexander Ron, Houston, TX (US)

(21) Appl. No.: 14/503,080

(22) Filed: Sep. 30, 2014

Related U.S. Application Data
(60) Provisional application No. 61/885,309, filed on Oct. 1, 2013.

(51) Int. Cl. B65D 81/02; B65D 85/00; B65D 25/28; B65D 41/00; B62B 1/00; B65D 25/20

(52) U.S. Cl. CPC B65D 81/02; B62B 1/00; B65D 25/20; B65D 25/2882; B65D 41/005; B65D 85/70; B63B 2017/0045
USPC 220/318; 280/29; 220/200; 220/315

(57) ABSTRACT

An apparatus for a portable sail container may store a sail. In an embodiment, the apparatus has a portable sail container having a body and a cap. The body and cap both have a hollow interior. In addition, the body and cap further have energy attenuating means located on the longitudinal interior ends of the body and the cap individually.

### CROSS-REFERENCE TO RELATED APPLICATIONS

This application is a non-provisional application that claims priority to U.S. Provisional Application Ser. No. 61/885,309 filed on Oct. 1, 2013, which is incorporated by reference herein in its entirety.

### STATEMENT REGARDING FEDERALLY SPONSORED RESEARCH OR DEVELOPMENT

Not applicable.

### BACKGROUND OF THE INVENTION

1. Field of the Invention

The present embodiments relate to sail protection, and more particularly, to portable containers that protect sails from external damage while maintaining sail integrity.

2. Background of the Invention

Sails typically must be in pristine condition to function properly. Creasing, bending, or crimping a sail may induce a loss of sail functionality. This may be of even greater importance in regards to the edges or ends of the sails.

A rolled or folded sail may be difficult to transport. For instance, a rolled or folded sail that is not placed in a container may suffer damage from external forces. For rolled or folded sails placed in a container, the container is typically of the appropriate size so as to not restrict the sail or cause damage. Furthermore, because folded sails are at a greater risk of damage due to the folding method, some sail types may be stored exclusively by rolling the sail. As compared to a folded sail, it may be more difficult to acquire a container shape and size that is suitable for a rolled sail.

Additional issues in the field result from damage to the rolled sails during placement of the sails in the container. If the rolled sail is not carefully placed in the container, the ends of the container may crimp the edges of the sail. Furthermore, airtight containers may seal in moisture that may damage a rolled sail.

Consequently, there is a need for a portable container that protects a sail from external damage while maintaining sail integrity.

### BRIEF SUMMARY OF SOME OF THE PREFERRED EMBODIMENTS

These and other needs in the art are addressed in one embodiment by a portable sail container comprising: a body and a cap, wherein the body and cap both comprise a hollow interior. The cap has an inner diameter larger than the outer diameter of the body, and the body and cap further comprise energy attenuating means located on the longitudinal interior ends of the body and the cap individually.

In another embodiment, these and other needs in the art are addressed by the portable sail container comprises a body and cap, wherein the cap has an inner diameter larger than the outer diameter of the body. The interior of the bottom of the body, and the interior of the cap comprise energy attenuating means. The body has further been bi-sected longitudinally so as to create two separate and distinct interior compartments.

In a further embodiment, these and other needs in the art are addressed by a portable sail container having a body. The body has a closed end and an open end. In addition, the portable sail container has a cap. The cap is tethered to the body. The portable sail container also has a tube. The tube has a tube closed end and a tube open end. Moreover, the portable sail container has a tube cap. The tube cap is tethered to the body. Further, the body, the cap, the tube, and the tube cap each have a hollow interior. The tube has a tube cap contacting portion and the body has a cap contacting portion. The cap has an inner diameter larger than an outer diameter of the cap contacting portion and the tube cap has an inner diameter larger than an outer diameter of the tube cap contacting portion. The body, the tube, the cap and the tube cap each further have energy attenuating means. The energy attenuating means of the body are disposed on an end of the body opposing an end of the body on which the cap is disposed. The portable sail container also has a means of motion.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will be made to the accompanying drawings in which:

FIG. 1 illustrates a sealed portable sail container in accordance with embodiments;

FIG. 2 illustrates an opening with a permeable membranes;

FIG. 3 illustrates a cross-sectional perspective of a bi-sected portable sail container in accordance with embodiments;

FIG. 4 illustrates a guide used to roll sails for proper storage inside the portable sail container; and

FIG. 5 illustrates a portable sail container with an additional tube.

### DETAILED DESCRIPTION OF THE PREFERRED EMBODIMENTS

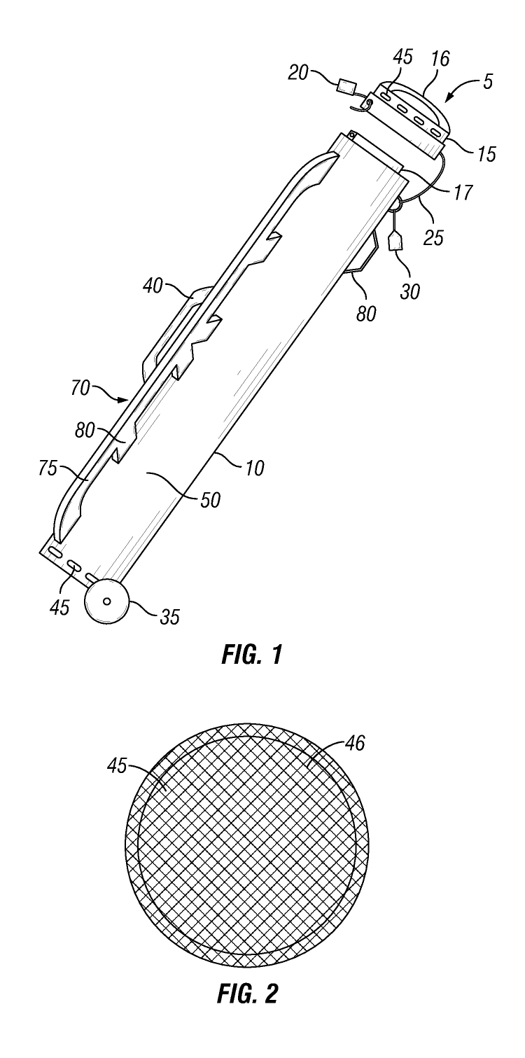

FIG. 1 illustrates portable sail container 5. In embodiments, portable sail container 5 is made of any material that is sufficiently durable to prevent cracking, fracturing, or any type of breakage due to impact or exposure to external factors such as heat or moisture. Without limitation, examples of materials include plastic, metal, stainless steel, aluminum, wood, composite materials, or any combination thereof. Portable sail container 5 may comprise a body 10 and a cap 15. In embodiments, body 10 and cap 15 are hollow. Body 10 may have a diameter between about five inches to about twenty inches, about ten inches to about fifteen inches, or about twelve inches to about eighteen inches. In alternative embodiments, body 10 has a diameter of about five inches, about six inches, about seven inches, about eight inches, about nine inches, about ten inches, about eleven inches, about twelve inches, about thirteen inches, about fourteen inches, about sixteen inches, about seventeen inches, about eighteen inches, about nineteen inches, or about twenty inches. Furthermore, body 10 may have any suitable length in which to accommodate a sail. In some embodiments, body 10 may have a length of about two feet to twenty five feet, about ten feet to about twenty feet, or about twelve feet to eighteen feet. In embodiments, a suitable length may be about two feet, about three feet, about four feet, about five feet, about six feet, about seven feet, about eight feet, about nine feet, about ten feet, about eleven feet, about twelve feet, about thirteen feet, about fourteen feet, about fifteen feet, about sixteen feet, about seventeen feet, about seventeen feet, about eighteen feet, about nineteen feet, about twenty feet, about twenty one feet, about twenty two feet, about twenty three feet, about twenty four feet, or about twenty five feet.

Likewise, cap 15 may have a diameter between about five inches to about twenty inches, about ten inches to about fifteen inches, or about twelve inches to about eighteen inches. In embodiments, cap 15 has a diameter about five inches, about six inches, about seven inches, about eight inches, about nine inches, about ten inches, about eleven inches, about twelve inches, about thirteen inches, about fourteen inches, about sixteen inches, about seventeen inches, about eighteen inches, about nineteen inches, about twenty inches, or about twenty-one inches. Cap 15 may be any suitable length. In an embodiment, cap 15 has a length about one inch to about six inches, about two inches to about four inches, or about three inches to about six inches. A suitable length may be about one inch, about two inches, about three inches, about four inches, about five inches, or about six inches. Cap 15 is attached to body 10 by any suitable means, in embodiments such means are capable of forming a seal. Without limitation, cap 15 may be attached to body 10 by a threaded connection, screw top, interference fitting, friction fitting, press fitting, snapping mechanism/snapping cap, or any combination thereof. Additionally, in some embodiments, an o-ring, not illustrated, may be used to create a seal between cap 15 and body 10. The o-ring may be attached to body 10 or cap 15 by any suitable means. Suitable means may include, but are not limited to, a groove, adhesive, friction fitting, interference fitting, or any combination thereof. The o-ring may be made of any such material suitable for sealing cap 15 to body 10. Suitable material may be, but is not limited to metal, stainless steel, aluminum, plastic, neoprene, cloth, or any combination thereof. In embodiments, cap 15 comprises an inner diameter that is larger than the outer diameter of the cap contacting area 17 of body 10. In embodiments, cap 15 may comprise an inner diameter that is smaller than the outer diameter of the cap contacting area 17 of body 10.

In embodiments, cap 15 may be locked to body 10 by locking means 20. Locking means 20 comprises any such locking means that may secure cap 15 to body 10. Without limitation, examples include slots for the insertion of key/combination locks, embedded key/combination locks, remote access locking mechanisms, or any combination thereof. Locking means 20 may be composed of any material sufficient for a durable locking mechanism. Examples include metal, stainless steel, aluminum, plastic, or any combination thereof. Additionally, cap 15 may have a handle 16, which may attach to cap 15 by any suitable means. Suitable means may include, but are not limited to, nuts and bolts, interference fitting, friction fitting, press fitting, snap buttons, fasteners, formed with the cap, or any combination thereof. Handle 46 may be made of any such material suitable for carrying or moving portable sail container 5 including, but not limited to metal, stainless steel, aluminum, plastic, or any combination thereof. Handle 46 may traverse the entire diameter of cap 15. In embodiments, handle 46 may be about two inches to about six inches, about three inches to about five inches, or about three inches to about six inches. In alternative embodiments, about two inches, about three inches, about four inches, about five inches, or about six inches.

Embodiments may also comprise a tether 25 between body 10 and cap 15. Tether 25 may attach body 10 to cap 15 and vice versa. Tether 25 may function to prevent cap 15 from being separated from body 10. In embodiments, tether 25 may be removable. Tether 25 may be made of any such material suitable for tying body 10 to cap 15. Without limitation, examples include cloth, plastic, nylon, leather, or any combination thereof.

In further embodiments, portable sail container 5 may comprise luggage tag 30. Luggage tag 30 may function to identify portable sail container 5. Luggage tag 30 may attach to either body 10 or cap 15. In optional embodiments, luggage tag 30 may attach to tether 25. Luggage tag 30 may be attached to portable sail container 5 by any suitable means, including threading or tying luggage tag 30 to or through a hole or slot, taping luggage tag 30 to portable sail container 5, sliding luggage tag 30 into a pouch or pocket affixed to portable sail container 5, or any combination thereof. Luggage tag 30 may comprise any material suitable for luggage tag 30 including cloth, paper, plastic, or the like.

In embodiments, a brace 70 may attach to body 10, adding structural strength and rigidity to body 10. Brace 70 may attach to body 10 by any suitable means. Suitable means may include, but are not limited to, nuts and bolts, interference fitting, friction fitting, press fitting, snap buttons, fasteners, formed with the cap, or any combination thereof. A plurality of braces 70 may attach along body 10 in any location suitable to prevent body 10 from bending, flexing, or collapsing. Brace 70 may be made of any such material suitable for carrying or moving portable sail container 5 including metal, stainless steel, aluminum, plastic, or any combination thereof. Furthermore, brace 70 may comprise a support bar 75 and a plurality of connection tabs 81. As illustrated in FIG. 1, brace 70 may traverse the length of body 10. In embodiments, brace 70 may traverse about a quarter of the length of body 10, about half the length of body 10, or about three quarters the length of body 10.

As illustrated in FIG. 1, body 10 may further comprise a buffer 80 or a plurality of buffers 80. Buffers 80 may be used to prevent portable sail container 5 from touching the ground when not in use. Buffers 80 may attach to body 10 by any suitable means. Suitable means may include, but are not limited to, nuts and bolts, interference fitting, friction fitting, press fitting, snap buttons, fasteners, formed with body 10, or any combination thereof. A plurality of buffers 80 may attach along body 10 in any location suitable to prevent body 10 from touching the ground when the portable sail container 5 is not in use. Buffers 80 may be made of any such material suitable for supporting portable sail container 5 including metal, stainless steel, aluminum, plastic, leather, neoprene, or any combination thereof Buffers 80 may be any suitable length in which to allow body 10 to be parallel with the ground when portable sail container 5 is not in use. Buffer 80 may be about one inch to about six inches, about two inches to about four inches, or about two inches to about six inches. In embodiments, buffers 80 may be about one inch, about two inches, about three inches, about four inches, about five inches, or about six inches.

In embodiments, portable sail container 5 may comprise motion means 35. Motion means 35 may be any such means suitable for transporting portable sail container 5. Without limitation, examples include wheels, low friction surfaces, moveable treads, or any combination thereof. As an example, in FIG. 1, motion means 35 are depicted as wheels. In embodiments where motion means 35 comprise wheels, the wheels may be stationary or, alternatively, capable of swiveling. The wheel may be any suitable wheel and configuration. Wheels may be connected by an axel, consisting of a metal rod, or be individual wheels. Motion means 35 may be made of any such material suitable for moving portable sail container 5. Suitable material may include, but is not limited to rubber, plastic, metal, stainless steel, aluminum, or any combination thereof. Motion means 35 may be attached to body 10, cap 15, or both. In embodiments, there may be a plurality of motion means 35 attached to body 10, cap 15, or both. Motion means 35 may attach to body 10, cap 15, or both by any suitable means. Suitable means may include, but are not limited to, nuts and bolts, interference fitting, friction fitting, press fitting, snap buttons, fasteners, or any combination thereof.

Embodiments of portable sail container 5 may comprise a handle 40. Handle 40 may be used for gripping and transporting portable sail container 5. Handle 40 may be made of any such material suitable for carrying or moving portable sail container 5 including metal, stainless steel, aluminum, plastic, or any combination thereof. Handle 40 may be attached to body 10, cap 15, brace 80, or any combination thereof. Handle 40 may also be formed as part of brace 80.

Body 10 may further comprise openings 45. Openings 45 may be of any number or shape. Specifically, the opening may be square, round, triangular, oval, polyhedral, or any combination thereof. In embodiments, opening 45 extend from the interior to the exterior of body 10 or cap 15. Openings 45 may be positioned on body 10, cap 15, or both. In embodiments, openings 45 may be positioned on any portion of body 10 and/or cap 15. As an example, in FIG. 1, openings 45 are positioned on the outer ends of body 10 and cap 15. Openings 45 may be of any size. In embodiments, openings 45 are large enough to allow moisture to escape portable sail container 5. As illustrated in FIG. 2, openings 45 may allow moisture to escape the portable sail container 5 while preventing moisture and other contaminates from entering the portable sail container 5 by way of a porous membrane 46. The porous membrane 46 may be of any suitable material suitable for properly protecting opening 45 while also allowing moisture to escape from body 10. Suitable material may include, but is not limited to metal, stainless steel, aluminum, plastic, cloth, leather, neoprene, fabric, or any combination thereof.

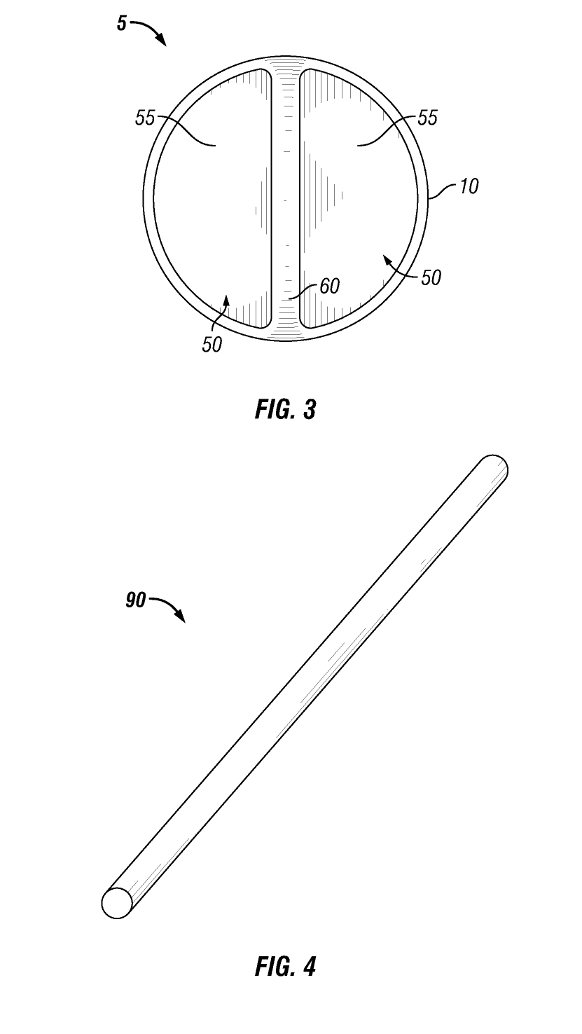

Referring now to FIG. 3, in embodiments, body 10 and cap 15 may comprise an interior 50. Interior 50 may be composed of any material sufficient for protecting a sail from external forces while simultaneously not damaging or deforming the sail. Examples include cloth, fabric, plastic, foam, metal, stainless steel, aluminum, or any combination thereof. In embodiments, the end 51 of interior 50 of body 10 and end 52 of cap 15 may be composed of energy attenuating means 55. In embodiments, energy attenuation means 55 are disposed on an opposing end of body 10 to the end of body 10 on which cap 15 is disposed. Energy attenuating means 55 may be any energy attenuating means suitable for protecting stored sail. Without limitation, examples include foam, cloth, fiber, gel or gel cushions, fabric, feathers or feathered materials, or any combination thereof. In embodiments, energy attenuating means 55 are sufficient to attenuate the energy of the sail as it is dropped into portable sail container 5. Energy attenuation means 55 may also attenuate the energy from a sail contacting cap 15, when placed on body 10, sealing the sail within portable sail container 5. In embodiments, energy attenuating means 55 prevents the edges of the sail from crimping.

Illustrated in FIG. 3, interior 50 of portable sail container 5 may be longitudinally bi-sected to form two distinct compartments via divider 60. In embodiments, divider 60 may be a uniform part of interior 50 or may be a separate component of interior 50. In embodiments where divider 60 is a separate component of interior 50, divider 60 may be inserted into interior 50 when portable sail container 5 is manufactured or inserted into portable sail container 5 at a later time. Divider 60 may attach to interior 50 of portable sail container 5 by any suitable means. Suitable means may be, but are not limited to, nuts and bolts, interference fitting, friction fitting, press fitting, snap buttons, fasteners, or any combination thereof. Divider 60 may be composed of any material suitable for dividing interior 50. Materials may include cloth, fabric, plastic, metal, stainless steel, aluminum, or any combination thereof. In embodiments, divider 60 substantially traverses the length of interior 50 of portable sail container 5. In alternate embodiments, divider 60 traverses a part of the length of interior 50. In embodiments, divider 60 may be about six inches to about twenty inches, about eight inches to about fifteen inches, or about ten inches to about eighteen inches. Divider 60 may traverse about a quarter, about half, or about three quarters the length of interior 50. The separate compartments of portable sail container 5 may be used to store additional components besides sails, such as battens, masts, or any combination thereof.

Portable sail container 5 may be of any size and shape sufficient to store a rolled up sail. Without limitation, in embodiments, portable sail container 5 is of sufficient size to store sails that fit C420, 1420, Opti, and 290er boats. In embodiments, portable sail container 5 does not telescope to fit the sail, but instead is large enough to fit the sail into the interior without any such method of elongation.

Portable sail container 5 may further comprise a guide 90, as illustrated in FIG. 4, which may be used to roll sails. Guide 90 may be hollow or solid, and may be removable from the interior of portable sail container 5. Guide 90 is placed at the edge of a sail and used to roll the sail around the guide. Guide 90 may be made of any such material suitable for properly rolling the sail including metal, stainless steel, aluminum, plastic, or any combination thereof. Guide 90 may be the length of portable sail container 5. Guide 90 may be about one inch to about six inches, about two inches to four inches, or about three inches to six inches. In other embodiments, guide 90 may be about one inch, about two inches, about three inches, about four inches, about five inches, or about six inches shorter than portable sail container 5.

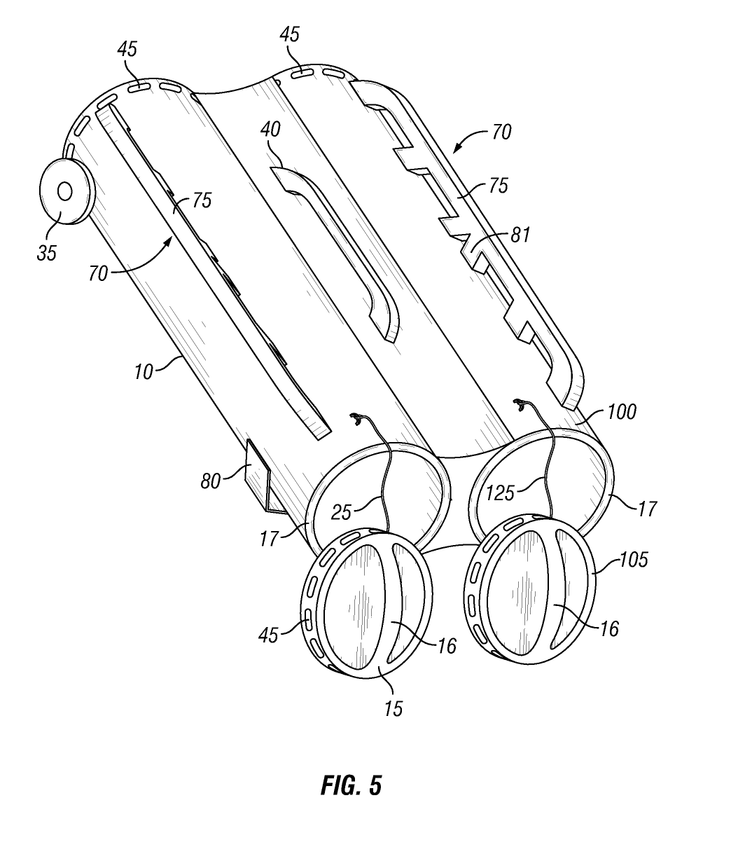

In further embodiments, as illustrated in FIG. 5, portable sail container 5 may further comprise tube 100 and tube cap 105. As illustrated in FIG. 5, tube 100 may attach to body 10, running the length of body 10. Tube 100 may be used to store additional boat parts, which may be used to attach a sail to a boat or for sailing purposes. Tube 100 may attach to body 10 by any suitable means. Suitable means may comprise, but are not limited to, nuts and bolts, interference fitting, friction fitting, press fitting, snap buttons, fasteners, formed to body 10, or any combination thereof. Furthermore, tube 100 and body 10 may be manufactured or formed as one individual piece. Tube 100 may have a diameter between about five inches to about twenty inches, about eight inches to about fifteen inches, or about ten inches to about eighteen inches. In embodiments, tube 100 may have a diameter of about five inches, about six inches, about seven inches, about eight inches, about nine inches, about ten inches, about eleven inches, about twelve inches, about thirteen inches, about fourteen inches, about sixteen inches, about seventeen inches, about eighteen inches, about nineteen inches, or about twenty inches. Furthermore, tube 100 may have a suitable length in which to accommodate a sail, boon, mast, and sprit roll. A length of tube 100 may be about two feet to about twenty five feet, about ten feet to about twenty feet, or about twelve feet to about eighteen feet. In embodiments, a suitable length may be about two feet, about three feet, about four feet, about five feet, about six feet, about seven feet, about eight feet, about nine feet, about ten feet, about eleven feet, about twelve feet, about thirteen feet, about fourteen feet, about fifteen feet, about sixteen feet, about seventeen feet, about seventeen feet, about eighteen feet, about nineteen feet, about twenty feet, about twenty one feet, about twenty two feet, about twenty three feet, about twenty four feet, or about twenty five feet.

Likewise, in embodiments as illustrated in FIG. 5, tube cap 105 may have a diameter between about five inches to about twenty inches, about ten inches to about fifteen inches, or about twelve inches to about eighteen inches. In embodiments, tube cap 105 may have a diameter of about five inches, about six inches, about seven inches, about eight inches, about nine inches, about ten inches, about eleven inches, about twelve inches, about thirteen inches, about fourteen inches, about sixteen inches, about seventeen inches, about eighteen inches, about nineteen inches, about twenty inches, or about twenty-one inches. Tube cap 105 may be any suitable length. A suitable length may be about one inch to about six inches, about two inches to about four inches, or about three inches to about six inches. In embodiments, length may be about one inch, about two inches, about three inches, about four inches, about five inches, or about six inches. Tube cap 105 is attached to tube 100 by any suitable means, in embodiments such means are capable of forming a seal. Without limitation, tube cap 105 may be attached to tube 100 by a threaded connection, screw top, interference fitting, friction fitting, press fitting, snapping mechanism/snapping cap, or any combination thereof. Additionally, in some embodiments an o-ring, not illustrated, may be used to create a seal between tube cap 105 and tube 100. The o-ring may be attached to tube 100 or tube cap 105 by any suitable means. Suitable means may include, but are not limited to, a groove, adhesive, friction fitting, interference fitting, or any combination thereof. The o-ring may be may be made of any such material suitable for sealing tube cap 105 to tube 100, including metal, stainless steel, aluminum, plastic, neoprene, cloth, nylon, or any combination thereof. In embodiments, tube cap 105 comprises an inner diameter that is larger than the outer diameter of the cap contacting area 17 of tube 100. In embodiments, tube cap 105 may comprise an inner diameter that is smaller than the outer diameter of the cap contacting area 17 of tube 100.

In embodiments of portable sail container 5, as illustrated in FIG. 5, tube cap 105 may be locked to tube 100 by locking means 20. Additionally, tube cap 105 may have a handle 16, which may attach to tube cap 105 by any suitable means. Suitable means may include, but are not limited to, nuts and bolts, interference fitting, friction fitting, press fitting, snap buttons, fasteners, formed with the cap, or any combination thereof. Handle 16 may be made of any such material suitable for the wear experienced when removing and replacing tube cap 105 with tube 100. Without limitation, examples of suitable materials may include metal, stainless steel, aluminum, plastic, or any combination thereof. Handle 16 may traverse the diameter of tube cap 105. Handle 16 may be about two inches to about six inches, about three inches to about five inches, or about three inches to about six inches. In embodiments, handle 16 may be about two inches, about three inches, about four inches, about five inches, or about six inches.

In additional embodiments of portable sail container 5, tube 100 may comprise a tether 125 between tube 100 and tube cap 105. Tether 125 may attach tube 100 to tube cap 105 and vice versa. Tether 125 may function to prevent tube cap 105 from being separated from tube 100. In optional embodiments, tether 125 may be removable. Tether 125 may be made of any such material suitable for tying tube 100 to cap 105. Without limitation, examples include cloth, plastic, nylon, leather, or any combination thereof.

In embodiments of portable sail container 5, illustrated in FIG. 5, a brace 70 may be attached to tube 100 by any suitable means. Suitable means may include, but are not limited to, nuts and bolts, interference fitting, friction fitting, press fitting, snap buttons, fasteners, formed with the cap, or any combination thereof. In embodiments, a plurality of braces 70 may attach along tube 100 in any location suitable to prevent tube 100 from bending, flexing, or collapsing. Braces 70 may be made of any such material suitable for carrying or moving portable sail container 5 including metal, stainless steel, aluminum, plastic, or any combination thereof. Furthermore, braces 70 may comprise a support bar 75 and plurality of connection tabs 81. As illustrated in FIG. 5, braces 70 may be about two feet to about twenty feet, about ten feet to about fifteen feet, or about twelve feet to about eighteen feet. Braces 70 may traverse the length of tube 100, about a quarter of the length of tube 100, about half the length of tube 100, or about three quarters the length of tube 100.

Further illustrated in FIG. 5, tube 100 may further comprise a buffer 80 or a plurality of buffers 80. Buffers 80 may attach to tube 100 by any suitable means. Suitable means may include, but are not limited to, nuts and bolts, interference fitting, friction fitting, press fitting, snap buttons, fasteners, formed with tube 100, or any combination thereof. A plurality of buffers 80 may attach along tube 100 in any location suitable to prevent tube 100 from touching the ground when the portable sail container 5 is not in use. Buffers 80 may be made of any such material suitable for supporting portable sail container 5 including metal, stainless steel, aluminum, plastic, leather, neoprene, or any combination thereof. Buffers 80 may be any suitable length in which to allow tube 100 to be parallel with the ground when portable sail container 5 is not in use. Buffer 80 may be about two inches to about six inches, about three inches to about five inches, or about three inches to about six inches. In alternate embodiments, buffers 80 may be about one inch, about two inches, about three inches, about four inches, about five inches, or about six inches.

In embodiments, tube 100 may further comprise openings 45. Openings 45 may be positioned on tube 100, tube cap 105, or both. In embodiments, openings 45 may be positioned on any portion of tube 100 and/or tube cap 105. As an example, in FIG. 1, openings 45 are positioned on the outer ends of tube 100 and tube cap 105. Openings 45 may be of any size. In embodiments, openings 45 are large enough to allow moisture to escape portable sail container 5. Openings 45 may allow moisture to escape the portable sail container 5 while preventing moisture and other contaminates from entering the portable sail container 5 by way of a porous membrane 46, as shown in FIG. 2. Porous membrane 46 may be of any suitable material suitable for properly protecting opening 45 while also allowing moisture to escape from tube 100. Suitable material may include, but is not limited to metal, stainless steel, aluminum, plastic, cloth, leather, neoprene, fabric, or any combination thereof.

In embodiments, motion means 35 may attach to tube 100 and tube cap 105. Motion means 35 may attach to tube 100, tube cap 105, body 10, and cap 15 at any suitable location. In embodiments there may be a plurality of motion means 35 that are used to support portable sail container 5.

As described above, tube 100 and tube cap 105 may have interior 50, energy attenuating means 55, and divider 60 as described above. Interior 50, energy attenuating means 55, and divider 60 may perform the same functions and have the same mechanical properties as they have in body 10 and cap 15.

Embodiments of portable sail container 5 may also comprise a GPS locator/transmitter. Any such GPS locator/transmitter may be sufficient, provided it is capable of the remote tracking and locating of portable sail container 5. The GPS locator/transmitter may be affixed to any portion of body 10, cap 15, or interior 50 of portable sail container 5.

Although the present invention and its advantages have been described in detail, it should be understood that various changes, substitutions and alterations may be made herein without departing from the spirit and scope of the invention as defined by the appended claims.

What is claimed is:

1. A portable sail container, comprising:
a body;
a cap; and
wherein the body and the cap both comprise hollow interiors, wherein the body has a cap contacting portion, and wherein the cap has an inner diameter larger than an outer diameter of the cap contacting portion, and further wherein the body and the cap each further comprise energy attenuating means, and wherein the energy attenuating means of the body are disposed on an end of the body opposing an end of the body on which the cap is disposed.

2. The portable sail container of claim 1, further comprising a means of motion.

3. The portable sail container of claim 2, wherein the means of motion are a set of wheels.

4. The portable sail container of claim 1, further comprising a locking means to lock the cap to the body.

5. The portable sail container of claim 1, wherein the cap forms a seal when attached to the body.

6. The portable sail container of claim 5, wherein the cap has an attached handle.

7. The portable sail container of claim 1, wherein the body has a plurality of openings, wherein the openings allow moisture to escape from the body.

8. The portable sail container of claim 1, wherein the body has a brace.

9. The portable sail container of claim 8, wherein the brace traverses a length of the body.

10. The portable sail container of claim 1, wherein a buffer is attached to the body.

11. A portable sail container, comprising:
a body, wherein the body has a closed end and an open end;
a cap, wherein the cap is tethered to the body;
a tube, wherein the tube has a tube closed end and a tube open end;
a tube cap, wherein the tube cap is tethered to the body; and
wherein the body, the cap, the tube, and the tube cap each comprise a hollow interior, wherein the tube has a tube cap contacting portion and the body has a cap contacting portion, and wherein the cap has an inner diameter larger than an outer diameter of the cap contacting portion and the tube cap has an inner diameter larger than an outer diameter of the tube cap contacting portion, and wherein the body, the tube, the cap and the tube cap each further comprise energy attenuating means, and wherein the energy attenuating means of the body are disposed on an end of the body opposing an end of the body on which the cap is disposed; and
a means of motion.

12. The portable sail container of claim 11, where the means of motion comprises a set of wheels.

13. The portable sail container of claim 12, wherein the set of wheels are attached to the body and the tube.

14. The portable sail container of claim 11, further comprising a locking means to lock the tube cap to the body.

15. The portable sail container of claim 14, wherein the cap has an attached handle.

16. The portable sail container of claim 11, wherein the tube cap attaches to an end of the tube.

17. The portable sail container of claim 16, wherein the tube cap has an attached handle.

18. The portable sail container of claim 11, wherein the body and the tube have a plurality of openings, and wherein the openings allow moisture to escape from the body.

19. The portable sail container of claim 11, wherein the body has a brace.

20. The portable sail container of claim 11, wherein the tube has a brace.
